(19) United States
(12) Patent Application Publication
(10) Pub. No.: US 2002/0117952 A1
(43) Pub. Date: Aug. 29, 2002

(54) Field emission display device and method for making the same

(76) Inventors: Christopher Chang, HsinChu City (TW); Edward Huang, Hsien (TW)

Correspondence Address: BACON & THOMAS, PLLC, 625 SLATERS LANE, FOURTH FLOOR, ALEXANDRIA, VA, 22314

(21) Appl. No.: 10/075,295

(22) Filed: Feb. 15, 2002

(30) Foreign Application Priority Data
Feb. 15, 2001 (TW) 90103450

(51) Int. Cl. H01J 9/02

(52) U.S. Cl. 313/309; 313/336; 445/24

(57) ABSTRACT

A field emission display device is disclosed, which has a first substrate; a second substrate coated with at least a layer of phosphor; a first conducting layer locating on one surface of said first substrate; a plurality of connecting-conducting lines; an insulating layer having a plurality of holes; a second conducting layer having a plurality of holes; a plurality of cones having at least one microtip; and a sealing gel sandwiched by said second substrate and said insulating layer. The method for fabricating the field emission display device illustrated above is also disclosed.

### BACKGROUND OF THE INVENTION

1. Field of the Invention

The present invention relates to a flat panel display device and a method for manufacturing the flat panel display device and, more particularly, to a field emission display device a method for manufacturing the field emission display device.

2. Description of Related Art

Liquid crystal display devices and field emission display devices are both famous flat panel display devices. Compared with liquid crystal display devices, field emission display devices have wider viewing angle, wider range for operating or displaying. Most field emission display devices (as shown in FIG. 1) are composed of a top substrate 700 coated with anodes 720 and phosphors 710, and a bottom substrate 670 mounted with cathodes 610, insulating layer 620, gates 630, cones 640, and holes 690. All the elements mentioned above are sandwiched between the bottom substrate 670 and the top substrate 700. Furthermore, these display elements of the field emission display devices illustrated above are also surrounded by a sealing gel 680. The sealing gel 680 is around the peripheral part of these two substrates and is sandwiched between the two substrates (the top substrate 700 and the bottom substrate 670). On the bottom substrate 670, there is a plurality of parallel connecting-conducting lines 660 locating on the insulating layer 620 to connect the gate 630. The connecting-conducting lines 660 extend toward the edge of the bottom substrate 670 to connect the external cables or provide a location for connecting other conductor 800 foreign to the substrate 670. In most cases, the connecting-conducting lines are always attached by the sealing gel to keep the elements inside the field emission display from outside dusts and pressure.

However, since the adherence between the sealing gel and the insulating layer of the traditional field emission display is poor. Cracks on the interface or in the sealing gel often form. In most cases, these cracks always result in serious leakage. The leakage further causes loss of vacuum that deteriorates the display quality of the field emission display. The loss of vacuum also shortens the lifetime of the field emission display.

Therefore, it is desirable to provide a field emission display device to mitigate and/or obviate the aforementioned problems.

### SUMMARY OF THE INVENTION

The object of the present invention is to provide a field emission display device or a field emission display baseplate to reduce the cracks on the sealing gel or the interface, to reduce the vacuum loss, to improve the display quality and to extend the lifetime of the field emission display.

Another object of the present invention is to provide a method for fabricating a field emission display baseplate or a field emission display device with less cracks on the sealing gel or the interface, less vacuum loss, higher display quality and longer lifetime of the field emission display.

To achieve the object, the field emission display baseplate of the present invention includes a first substrate; a first conducting layer locating on one surface of said first substrate; an insulating layer having a plurality of holes, said insulating layer locates over the surface of said first conducting layer or over partial surface of said first substrate; a second conducting layer having a plurality of holes, said second conducting layer locates on said insulating layer; a plurality of cones having at least one microtip, said cones locate one the surface of said first conducting layer inside said holes, said microtips are surrounded by the walls of insulating layer or said second conducting layer; and a plurality of connecting-conducting lines locating on the peripheral parts of said first substrate; wherein said first conducting layer doesn't connect with said second conducting layer; said first conducting layer doesn't connect with said connecting-conducting lines; and said connecting-conducting lines connect second conducting layer.

The field emission display device of the present invention includes a first substrate; a second substrate coated with at least a layer of phosphor; a first conducting layer locating on one surface of said first substrate; a plurality of connecting-conducting lines locating on the peripheral parts of said first substrate; an insulating layer having a plurality of holes, said insulating layer locates over the surface of said first conducting layer, over the surface of connecting-conducting lines, or over partial surface of said first substrate; a second conducting layer having a plurality of holes, said second conducting layer locates on said insulating layer; a plurality of cones having at least one microtip, said cones locate one the surface of said first conducting layer inside said holes, said microtips are surrounded by the walls of insulating layer or said second conducting layer; and a sealing gel sandwiched by said second substrate and said insulating layer over said connecting-conducting lines or over said first substrate; wherein said first conducting layer doesn't connect with said second conducting layer; said first conducting layer doesn't connect with said connecting-conducting lines; and said connecting-conducting lines connect second conducting layer.

The method for fabricating a field emission display baseplate of the present invention, includes following steps: providing a first substrate; forming a first conducting layer and connecting-conducting lines on one surface of said first substrate, wherein said connecting-conducting lines locating on the peripheral part of said first substrate, and said first conducting layer doesn't connect with said connecting-conducting lines; forming an insulating layer over the surface of said first conducting layer; forming a second conducting layer on the surface of said insulating layer; forming a plurality of holes penetrating through said insulating layer and said second conducting layer to said first conducting layer; and forming a plurality of cones on the first conducting layer of said holes.

The method for fabricating a field emission display of the present invevention, includes following steps: providing a first substrate and a second substrate, wherein at least one surface of said second substrate is coated with at least a layer of phosphor; forming a first conducting layer and connecting-conducting lines on one surface of said first substrate, wherein said connecting-conducting lines locating on the peripheral part of said first substrate, and said first conducting layer doesn't connect with said connecting-conducting lines; forming at least an insulating layer over the surface of said first conducting layer and over part of the surface of said connecting-conducting lines; forming a connecting-hole or a connecting-groove penetrating through said insulating layer for each connecting-conducting lines; forming a second conducting layer on said insulating layer, wherein part of said second insulating layer connects said connecting-conducting lines through said connecting-hole or said connecting-groove; forming a plurality of holes penetrating through said insulating layer and said second conducting layer to said first conducting layer; forming a plurality of cones having at least one microtip on the first conducting layer of said holes; and forming a plurality of cones on the first conducting layer of said holes.

Other objects, advantages, and novel features of the invention will become more apparent from the following detailed description when taken in conjunction with the accompanying drawings.

### BRIEF DESCRIPTION OF THE DRAWINGS

FIG. 1 is a cross-section view of a traditional field emission display device.

FIG. 2 is a cross-section view of an embodiment of the field emission display device of the present invention.

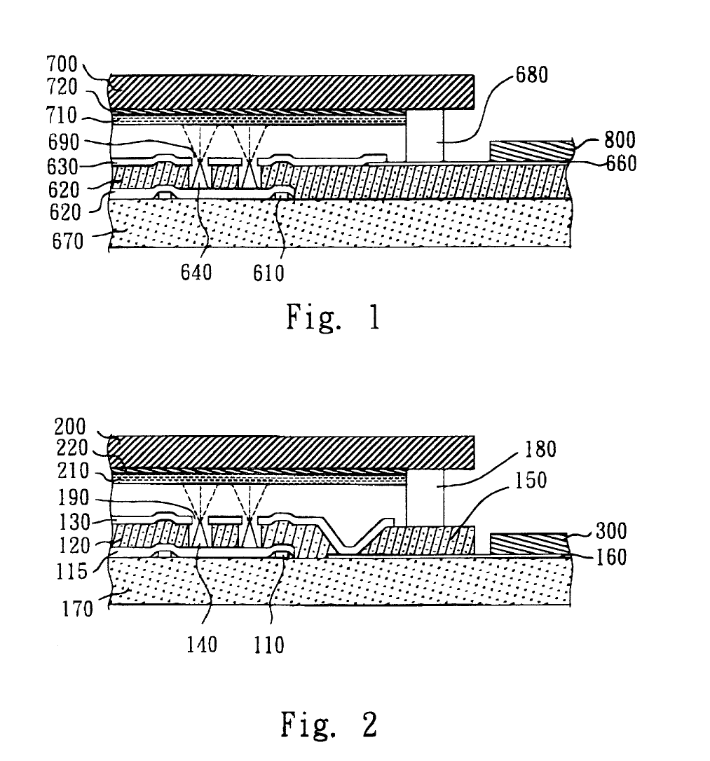

### DETAILED DESCRIPTION OF THE PREFERRED EMBODIMENT

The cathodes (first conducting layers) of the present invention can be arranged to contact the cones directly or indirectly. Preferably, the cathodes (first conducting layers) connecting the cones in the holes through resist layers. The cathodes (first conducting layers) of the baseplate of the present invention can be arranged in any forms. Preferably, the cathodes (first conducting layers) are arranged as parallel stripes. The second conducting layer of the baseplate of the present invention connects part of said second insulating layer through either connecting-holes or connecting-grooves. Preferably, the second conducting layer of the baseplate of the present invention connects part of said second insulating layer through connecting-grooves. The first substrate of the present invention can be any conventional material for substrate. Preferably, the first substrate of the present invention is made by glass. The second substrate of the present invention can be any conventional material for substrate. Preferably, the second substrate of the present invention is made by glass. The shape of the holes can be any shape. Preferably, the holes are cylindrical holes. The insulating layer of the present invention can be any conventional insulating material. Preferably, the insulating layer of the present invention is silicone oxide. The first conducting layer of the present invention can be any conventional conducting layer material. Preferably, the first conducting layer of the present invention is a metal layer containing tantalum, niobium, or molybdenum. Most preferably, the first conducting layer is a metal layer containing niobium. The second conducting layer of the present invention can be any conventional conducting material. Preferably, the second conducting layer of the present invention is a metal layer.

With reference to FIG. 2, there is shown a cross-section view of an embodiment of the field emission display device of the present invention. The field emission display device of the present embodiment includes a bottom baseplate 170 (the first substrate) and a top glass substrate 200 (the second substrate), and a sealing gel 180 sandwiched between the top glass 200 (the second substrate) and the bottom baseplate 170 (the first substrate). In the active area (displaying area) of the bottom baseplate 170 (the first substrate), there are patterned cathode layer 110 (the first conducting layer), patterned resist layer 115, insulating layer 120 with patterned holes, patterned gate layer 130 (the second conducting layer), cones with emitter microtips 140, and the sealing insulating layer 150. The bottom baseplate 170 is made of glass in the present embodiment. The patterned cathode layer 110 (the first conducting layer) locates on the surface substrate. The patterned cathode layer 110 (the first conducting layer) can connect the cones directly or through a plurality of resist layer. In the field emission display baseplate of the present embodiment, the patterned cathode layer 110 (the first conducting layer) can connect the cones 140 directly or through a resist layer 115. On the surface of the cathode layer 110 (the first conducting layer), there is coated an insulating layer 120. The insulating layer 120 is a layer patterned with a plurality of holes 190. The holes 190 are allowed to form at least a cone 140 having at least one microtip. Further, a patterned gate 130 forms on the surface of the insulating layer 120. There are openings on the patterned gate 130 to coordinate with the holes of the insulating layer 120. Any conventional conducting material can be used for the cones 140 and cathode layer 110 (the first conducting layer). In the present embodiment, the cones 140 and cathode layer 110 (the first conducting layer) are made by metal containing niobium. Any conventional insulating material can be used for the insulating layer 120. In the present embodiment, insulating layer 120 is made of silicone oxide. Close to the peripheral area of the display panel, there is formed a plurality of patterned connecting-conducting lines 160. The patterned connecting-conducting lines 160 are formed on the peripheral area of the bottom baseplate 170. The patterned connecting-conducting lines 160 are used to connect external conductors for signals or power. On the surface of the connecting-conducting lines or the surface of the peripheral bottom baseplate 170, another insulating layer, i.e. connecting-insulating layer 150, forms. Between the insulating layer 120 and the connecting-insulating layer 150, connecting-grooves or connecting-holes penetrating the insulating layer 120 and the connecting-insulating layer 150 form. The connecting-grooves or the connecting-holes are to provide channels to connect the patterned gate layer 130 and the patterned connecting-conducting lines 160. In the present embodiment, the connecting-grooves are in shapes of “V”. The connecting-conducting lines 160 and the patterned cathode layer 110 (the first conducting layer) are made by the same materials. Similar to the patterned cathode layer 110 (the first conducting layer), the connecting-conducting lines 160 can be made by any conventional conducting material. Preferably, the connecting-conducting lines 160 is made by metal containing tantalum, niobium, or molybdenum. In the present embodiment, the connecting-conducting lines 160 are made by metal containing niobium. The cathode layer 110 (the first conducting layer) of the present embodiment doesn't connect with the gate layer 130 (second conducting layer). The cathode layer 110 (the first conducting layer) of the present embodiment doesn't connect with connecting-conducting lines 160, either.

On the other hand, inside the surface of the top glass 200 (the second substrate), there is coated at least a layer of anode 220 and a layer of phosphor 210. The anode 220 can be any conventional conducting material. In the present embodiment, the anode 220 is made by patterned ITO (indium tin oxide). The top substrate 200 and the bottom baseplate 100 is combined through the binding of the sealing gel 180. The sealing gel 180 is coated on the surface of the connecting-insulating layer 150 and sandwiched between the top substrate 200 and the connecting-insulating layer 150. Since there is no contact between the surface of the connecting-conducting lines 160 and the sealing gel 180, the cracks' or erosion can be effectively reduced. The adherence of the sealing gel on the insulating layer is better than that of the sealing gel on the metal. In other words, this design of the field emission display device of the present embodiment homogenizes the sealing area of the field emission display device to enhance the tightness of sealing area.

The field emission display device of the present invention is made by forming a patterned cathode layer 110, patterned resist layer 115, and patterned connecting-conducting lines 160 on the bottom baseplate 170 (the first substrate) through traditional steps (e.g. CVD, sputtering, and photolithography). Since the cathode layer 110 and the patterned connecting-conducting lines 160 are made by the same materials (e.g. metal containing niobium), they can be made at the same time. However, the cathode layer 110 (the first conducting layer) doesn't connect with connecting-conducting lines 160. Then patterned insulating layers (silicone oxide layer) both in the active area (including the insulating layer with patterned holes) and the peripheral area (including the connecting-insulating layer and the connecting-grooves) forms through traditional steps (e.g. CVD, sputtering, and photolithography). Furthermore, a patterned layer of gate electrode forms on the insulating layer. The patterned gate layer contacts the connecting-conducting lines 160 through connecting-grooves in the peripheral area of the baseplate. The cones having microtips form inside the holes subsequently. The top substrate 200 is coated with a layer of anode (e.g. ITO) and a layer of phosphor through traditional process. The top substrate and the baseplate is sealed with coating and curing the gel on the surface of the connecting-insulating layer 150 and the top substrate through heat, pressure or light. After vacuuming the inside space between the top substrate and the baseplate, the field emission display device of the present invention is achieved.

Since the connecting-conducting lines doesn't contact with the sealing gel and the external conducting lines contact the gate layers through the connecting-conducting lines 160 made by metal containing niobium, the erosion and the cracks caused by traditional Cr lines and sealing gels can be reduced greatly. In addition, since the adherence between the insulating layer is better than that between the sealing gel and the connecting-conducting lines, the tightness between the top substrate and the baseplate improves a lot, too. On the other hand, since the connecting-conducting lines and the cathodes can be formed at the same time (e.g. by using one mask for photolithography), the process for producing the field emission display baseplate can be simplified. In other words, less masks or steps are needed for the method for fabricating the field emission display devices of the present invention. Compared with the traditional method for fabricating the field emission display devices, less cost and less time is needed for the method for fabricating the field emission display devices of the present invention.

Although the present invention has been explained in relation to its preferred embodiment, it is to be understood that many other possible modifications and variations can be made without departing from the spirit and scope of the invention as hereinafter claimed.

What is claimed is:

1. A method for fabricating a field emission display baseplate, comprising following steps:
providing a first substrate;
forming a first conducting layer and connecting-conducting lines on one surface of said first substrate, wherein said connecting-conducting lines locating on the peripheral part of said first substrate, and said first conducting layer doesn't connect with said connecting-conducting lines;
forming an insulating layer over the surface of said first conducting layer;
forming a second conducting layer on the surface of said insulating layer;
forming a plurality of holes penetrating through said insulating layer and said second conducting layer to said first conducting layer; and
forming a plurality of cones on the first conducting layer of said holes.

2. The method as claimed in claim 1, further comprising forming a resist layer on said first conducting layer before forming said insulating layer over said surface of said first conducting layer

3. A method for fabricating a field emission display, comprising following steps:
providing a first substrate and a second substrate, wherein at least one surface of said second substrate is coated with at least a layer of phosphor;
forming a first conducting layer and connecting-conducting lines on one surface of said first substrate, wherein said connecting-conducting lines locating on the peripheral part of said first substrate, and said first conducting layer doesn't connect with said connecting-conducting lines;
forming at least an insulating layer over the surface of said first conducting layer and over part of the surface of said connecting-conducting lines;
forming a connecting-hole or a connecting-groove penetrating through said insulating layer for each connecting-conducting lines;
forming a second conducting layer on said insulating layer, wherein part of said second insulating layer connects said connecting-conducting lines through said connecting-hole or said connecting-groove;
forming a plurality of holes penetrating through said insulating layer and said second conducting layer to said first conducting layer;
forming a plurality of cones having at least one microtip on the first conducting layer of said holes; and
combining said first substrate with said second substrate, and sealing the periphery of said first substrate and said second substrate with gel, wherein said gel is sandwiched between said second substrate and said insulating layer over said connecting-conducting lines or over said first substrate.

4. The method as claimed in claim 1 or 3, wherein said first substrate is made by glass.

5. The method as claimed in claim 3, wherein said second substrate is made by glass.

6. The method as claimed in claim 1 or 3, wherein said hole is a cylindrical hole.

7. The method as claimed in claim 1 or 3, wherein said insulating layer is made by silicone oxide.

8. The method as claimed in claim 1 or 3, wherein said first conducting layer is a metal layer containing tantalum, niobium, or molybdenum.

9. The method as claimed in claim 1 or 3, wherein said first conducting layer is a metal layer containing niobium.

10. The method as claimed in claim 1 or 3, wherein said second conducting layer is a metal layer.

11. A field emission display baseplate, comprising:
a first substrate;
a first conducting layer locating on one surface of said first substrate;
an insulating layer having a plurality of holes, said insulating layer locates over the surface of said first conducting layer or over partial surface of said first substrate;
a second conducting layer having a plurality of holes, said second conducting layer locates on said insulating layer;
a plurality of cones having at least one microtip, said cones locate one the surface of said first conducting layer inside said holes, said microtips are surrounded by the walls of insulating layer or said second conducting layer; and
a plurality of connecting-conducting lines locating on the peripheral parts of said first substrate;
wherein said first conducting layer doesn't connect with said second conducting layer; said first conducting layer doesn't connect with said connecting-conducting lines; and said connecting-conducting lines connect second conducting layer.

12. The field emission display baseplate as claimed in claim 11, further comprising a resist layer sandwiched between said insulating layer and said first conducting layer.

13. The field emission display device, comprising:
a first substrate;
a second substrate coated with at least a layer of phosphor;
a first conducting layer locating on one surface of said first substrate;
a plurality of connecting-conducting lines locating on the peripheral parts of said first substrate;
an insulating layer having a plurality of holes, said insulating layer locates over the surface of said first conducting layer, over the surface of connecting-conducting lines, or over partial surface of said first substrate;
a second conducting layer having a plurality of holes, said second conducting layer locates on said insulating layer;
a plurality of cones having at least one microtip, said cones locate one the surface of said first conducting layer inside said holes, said microtips are surrounded by the walls of insulating layer or said second conducting layer; and
a sealing gel sandwiched by said second substrate and said insulating layer over said connecting-conducting lines or over said first substrate;
wherein said first conducting layer doesn't connect with said second conducting layer; said first conducting layer doesn't connect with said connecting-conducting lines; and said connecting-conducting lines connect second conducting layer.

14. The field emission display device as claimed in claim 13, wherein said first substrate is made by glass.

15. The field emission display device as claimed in claim 13, wherein said second substrate is made by glass.

16. The field emission display device as claimed in claim 13, wherein said hole is a cylindrical hole.

17. The field emission display device as claimed in claim 13, wherein said insulating layer is made by silicone oxide.

18. The field emission display device as claimed in claim 13, wherein said first conducting layer is a metal layer containing tantalum, niobium, or molybdenum.

19. The field emission display device as claimed in claim 13, wherein said first conducting layer is a metal layer containing niobium.

20. The field emission display device as claimed in claim 13, wherein said second conducting layer is a metal layer.
